(19) United States
(12) Patent Application Publication
(10) Pub. No.: US 2026/0246921 A1
(43) Pub. Date: Aug. 20, 2026

(54) Methods and Apparatus of Intra Block Copy with Multiple Hypothesis Prediction for Video Coding

(71) Applicant: MEDIATEK INC., Hsinchu City (TW)

(72) Inventors: Chen-Yen LAI, Hsinchu City (TW); Yu-Cheng LIN, Hsinchu City (TW); Chih-Hsuan LO, Hsinchu City (TW); Man-Shu CHIANG, Hsinchu City (TW); Tzu-Der CHUANG, Hsinchu City (TW); Ching-Yeh CHEN, Hsinchu City (TW); Chih-Wei HSU, Hsinchu City (TW); Yu-Wen HUANG, Hsinchu City (TW); Yi-Wen CHEN, San Jose, CA (US); Olena CHUBACH, San Jose, CA (US); Cheng-Yen CHUANG, San Jose, CA (US)

(21) Appl. No.: 19/472,069

(22) PCT Filed: Apr. 12, 2024
(86) PCT No.: PCT/CN2024/087441

§ 371 Date: Oct. 2, 2025

Related U.S. Application Data
(60) Provisional application No. 63/495,590, filed on Apr. 12, 2023.
(60) Provisional application No. 63/496,036, filed on Apr. 14, 2023.
(60) Provisional application No. 63/497,241, filed on Apr. 20, 2023.
(60) Provisional application No. 63/460,979, filed on Apr. 21, 2023.
(60) Provisional application No. 63/503,734, filed on May 23, 2023.

(51) Int. Cl. H04N 19/105; H04N 19/159; H04N 19/176; H04N 19/196; H04N 19/577; H04N 19/593

(52) U.S. Cl. CPC H04N 19/105; H04N 19/159; H04N 19/176; H04N 19/196; H04N 19/577; H04N 19/593

(57) ABSTRACT

Method and apparatus for blended IBC mode. According to the method, a first predictor or a first hypothesis is derived by using a first prediction mode comprising IBC (Intra Block Copy) prediction mode or IntraTMP (Intra Template Matching Prediction) mode. A second predictor is derived. A blended predictor is derived by blending the first predictor or the first hypothesis with the second predictor. The current block is encoded or decoded by using a predictor candidate set comprising the blended predictor. According to another method, for IBC-CIIP (Combined Intra Block Copy and Intra Prediction), the behavior is aligned among the inter prediction mode, the IBC AMVP mode and the IBC merge mode.

### CROSS REFERENCE TO RELATED APPLICATIONS

The present invention is a non-Provisional Application of and claims priority to U.S. Provisional Patent Application No. 63/495,590, filed on Apr. 12, 2023, U.S. Provisional Patent Application No. 63/496,036, filed on Apr. 14, 2023, U.S. Provisional Patent Application No. 63/497,241, filed on Apr. 20, 2023, U.S. Provisional Patent Application No. 63/460,979, filed on Apr. 21, 2023, and U.S. Provisional Patent Application No. 63/503,734, filed on May 23, 2023. The U.S. Provisional Patent Applications are hereby incorporated by reference in their entireties.

### FIELD OF THE INVENTION

The present invention relates to video coding system. In particular, the present invention relates to Intra Block Copy and/or Intra Template Matching Prediction.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Intra Template Matching Prediction

Intra template matching prediction (IntraTMP) is a special intra prediction mode that copies the best prediction block from the reconstructed part of the current frame, whose L-shaped template matches the current template. For a predefined search range, the encoder searches for the most similar template matched with the current template in a reconstructed part of the current frame and uses the corresponding block as a prediction block. The encoder then signals the usage of this mode, and the same prediction operation is performed at the decoder side.

The prediction signal is generated by matching the L-shaped causal neighbour of the current block with another block in a predefined search area in FIG. 2 consisting of:
R1: current CTU
R2: top-left CTU
R3: above CTU
R4: left CTU

In FIG. 2, the current block 210 in R1 is matched with the corresponding block 212 in R2. The templates for the current block and the matched block are shown as darker-colour L-shaped areas. Area 222 corresponds to reconstructed region in the current picture 220. Sum of absolute differences (SAD) is used as a cost function. Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW ,$$

$$SearchRange\_h = a * BlkH ,$$

where ‘a’ is a constant that controls the gain/complexity trade-off. In practice, ‘a’ is equal to 5.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min (BlkW, BlkH)/2.

The intra template matching tool is enabled for CUs with size less than or equal to 64 in width and height. This maximum CU size for Intra template matching is configurable.

The intra template matching prediction mode is signalled at CU level through a dedicated flag when DIMD (Decoder-side Intra Mode Derivation) is not used for the current CU.

### Current Picture Referencing

Motion Compensation, one of the key technologies in hybrid video coding, explores the pixel correlation between adjacent pictures. It is generally assumed that, in a video sequence, the patterns corresponding to objects or background in a frame are displaced to form corresponding objects in the subsequent frame or correlated with other patterns within the current frame. With the estimation of such displacement (e.g. using block matching techniques), the pattern can be mostly reproduced without the need to re-code the pattern. Similarly, block matching and copy has also been tried to allow selecting the reference block from the same picture as the current block. It was observed to be inefficient when applying this concept to camera captured videos. Part of the reasons is that the textual pattern in a spatial neighbouring area may be similar to the current coding block, but usually with some gradual changes over the space. It is difficult for a block to find an exact match within the same picture in a video captured by a camera. Accordingly, the improvement in coding performance is limited.

However, the situation for spatial correlation among pixels within the same picture is different for screen contents. For a typical video with texts and graphics, there are usually repetitive patterns within the same picture. Hence, intra (picture) block compensation has been observed to be very effective. A new prediction mode, i.e., the intra block copy (IBC) mode or called current picture referencing (CPR), has been introduced for screen content coding to utilize this characteristic. In the CPR mode, a prediction unit (PU) is predicted from a previously reconstructed block within the same picture. Further, a displacement vector (called block vector or BV) is used to indicate the relative displacement from the position of the current block to that of the reference block. The prediction errors are then coded using transformation, quantization and entropy coding. An example of IBC compensation is illustrated in FIG. 3, where block 312 is a corresponding block for block 3210, and block 322 is a corresponding block for block 320. In this technique, the reference samples correspond to the reconstructed samples of the current decoded picture prior to in-loop filter operations, both deblocking and sample adaptive offset (SAO) filters in HEVC.

The very first version of IBC was proposed in JCTVC-M0350 (Budagavi et al., AHG8: Video coding using Intra motion compensation, Joint Collaborative Team on Video Coding (JCT-VC) of ITU-T SG16 WP3 and ISO/IEC JTC 1/SC 29/WG11, 13th Meeting: Incheon, KR, 18-26 Apr. 2013, Document: JCTVC-M0350) to the HEVC Range Extensions (RExt) development. In this version, the IBC compensation was limited to be within a small local area, with only 1-D block vector and only for block size of 2N×2N. Later, a more advanced IBC design has been developed during the standardization of HEVC SCC (Screen Content Coding).

### Reconstruction-Reordered IBC (RR-IBC)

A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP (Advanced Motion Vector Prediction) coded block, indicating whether the reconstruction is flipped, and if it is flipped, another flag is further signalled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signalled and inferred to be equal to 0. Similarly, the horizontal component of the BV is not signalled and inferred to be equal to 0 when a vertical flip is applied.

To better utilize the symmetry property, a flip-aware BV adjustment approach is applied to refine the block vector candidate. For example, as shown in FIG. 4A and FIG. 4B, (x_{nbr}, y_{nbr}) and (x_{cur}, y_{cur}) represent the coordinates of the centre sample of the neighbouring block and the current block, respectively, BV^{nbr} and BV^{cur} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip (as shown in FIG. 4A), i.e., BV^{cur}ₕ=2 (x_{nbr}−x_{cur})+B^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip (as shown in FIG. 4B), i.e., BV_{cur}^{v}=2 (y_{nbr}−y_{cur})+BV^{nbr}_{y}.

IBC Merge Mode with Block Vector Differences (IBC-MBVD)

Affine-MMVD and GPM-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the Rice code with the parameter equal to 1.

An IBC-MBVD coded block does not inherit flip type from a RR-IBC coded neighbour block.

### IBC-LIC

In JVET-AC0112 (Yang Wang, et. al., “EE2-3.6: IBC-CIIP, IBC-GPM, and IBC-LIC”, Joint Video Experts Team (JVET) of ITU-T SG 16 WP 3 and ISO/IEC JTC 1/SC 29, 29th Meeting, by teleconference, 11-20 Jan. 2023, Document: JVET-AC0112), IBC-LIC is adopted in ECM (Enhanced Compression Model). Intra block copy with Local Illumination Compensation (IBC-LIC) is a coding tool which compensates the local illumination variation within a picture between the CU coded with IBC and its prediction block with a linear equation. The parameters of the linear equation are derived same as LIC for inter prediction except that the reference template is generated using block vector in IBC-LIC. IBC-LIC can be applied to IBC AMVP mode and IBC merge mode. IBC AMVP (IBC with Advanced Motion Vector Prediction Mode) corresponds to the IBC mode that directly signals motion vector predictor index, and motion vector difference if necessary. The IBC AMVP is similar to the well-known inter AMVP. However, the motion vectors refer to block vectors of IBC. The name IBC AMVP is used in this disclosure. For IBC AMVP mode, an IBC-LIC flag is signalled to indicate the use of IBC-LIC. For IBC merge mode, the IBC-LIC flag is inferred from the merge candidate.

### IBC-GPM

In JVET-AC0112, IBC-GPM is adopted in ECM. Intra block copy with geometry partitioning mode (IBC-GPM) is a coding tool which divides a CU into two sub-partitions geometrically. The prediction signals of the two sub-partitions are generated using IBC and intra prediction. IBC-GPM can be applied to regular IBC merge mode or IBC TM merge mode. An intra prediction mode (IPM) candidate list is constructed using the same method as GPM with inter and intra prediction for intra prediction, and the IPM candidate list size is pre-defined as 3. There are 48 geometry partitioning modes in total, which are divided into two geometry partitioning mode sets as follows:

TABLE 1
Geometry partitioning modes in the first
geometry partitioning mode set

| ibc_gpm_partition_idx | 0 | 1 | 2 | 3 | 4 | 5 | 6 | 7 |
|---|---|---|---|---|---|---|---|---|
| angleIdx | 0 | 0 | 8 | 8 | 16 | 16 | 24 | 24 |
| distanceIdx | 1 | 3 | 1 | 3 | 1 | 3 | 1 | 3 |

TABLE 2
Geometry partitioning modes in the second
geometry partitioning mode set

| ibc_gpm_partition_idx | 0 | 1 | 2 | 3 | 4 | 5 | 6 | 7 | 8 | 9 |
|---|---|---|---|---|---|---|---|---|---|---|
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

When IBC-GPM is used, an IBC-GPM geometry partitioning mode set flag is signalled to indicate whether the first or the second geometry partitioning mode set is selected, followed by the geometry partitioning mode index. An IBC-GPM intra flag is signalled to indicate whether intra prediction is used for the first sub-partition. When intra prediction is used for a sub-partition, an intra prediction mode index is signalled. When IBC is used for a sub-partition, a merge index is signalled.

### IBC-CHIP

In JVET-AC0112, IBC-CIIP is adopted in ECM. Combined intra block copy and intra prediction (IBC-CIIP) is a coding tool for a CU which uses IBC with merge mode and intra prediction to obtain two prediction signals, and the two prediction signals are weighted summed to generate the final prediction. Specifically, if the intra prediction is planar or DC mode, the final prediction is obtained as follows:

$$P = ( {w}_{i b c} * {P}_{i b c} + ( ( 1 << shift ) - {w}_{i b c} ) * {P}_{intra} + ( 1 << ( shift - 1 ) ) ) >> shift ,$$

wherein P_{ibc} and Pᵢₙₜᵣₐ denote the IBC prediction signal and intra prediction signal, respectively. (w_{ibc}, shift) are set equal to (13, 4) and (1, 1) for IBC merge mode and IBC AMVP mode.
Adaptive Reordering of Merge Candidates with Template Matching (ARMC-TM)

The merge candidates are adaptively reordered with template matching (TM). The reordering method is applied to regular merge mode, TM merge mode, and affine merge mode (excluding the SbTMVP (Subblock-based Temporal Motion Vector Prediction) candidate). For the TM merge mode, merge candidates are reordered before the refinement process.

An initial merge candidate list is firstly constructed according to a given checking order, such as spatial, TMVPs, non-adjacent, HMVPs, pairwise, virtual merge candidates. Then the candidates in the initial list are divided into multiple subgroups. For the template matching (TM) merge mode, adaptive DMVR mode, each merge candidate in the initial list is firstly refined by using TM/multi-pass DMVR. Merge candidates in each subgroup are reordered to generate a reordered merge candidate list and the reordering is according to cost values based on template matching. The index of selected merge candidate in the reordered merge candidate list is signalled to the decoder. For simplification, merge candidates in the last but not the first subgroup are not reordered. All the zero candidates from the ARMC reordering process are excluded during the construction of Merge motion vector candidates list. The subgroup size is set to 5 for regular merge mode and TM merge mode. The subgroup size is set to 3 for affine merge mode.

### Cost Calculation

The template matching cost of a merge candidate during the reordering process is measured by the SAD between samples of a template of the current block and their corresponding reference samples. The template comprises a set of reconstructed samples neighbouring to the current block. Reference samples of the template are located by the motion information of the merge candidate. When a merge candidate utilizes bi-directional prediction, the reference samples of the template of the merge candidate are also generated by bi-prediction as shown in FIG. 5.

In FIG. 5, block 512 corresponds to a current block in current picture 510, blocks 522 and 532 correspond to reference blocks in reference pictures 520 and 530 in list 0 and list 1 respectively. Templates 514 and 516 are for current block 512, templates 524 and 526 are for reference block 522, and templates 534 and 536 are for reference block 532. Motion vectors 540, 542 and 544 are the list 0 motion vector of the merge candidate and motion vectors 550, 552 and 554 are the list 1 motion vector of the merge candidate.

### Refinement of the Initial Merge Candidate List

When multi-pass DMVR is used to derive the refined motion to the initial merge candidate list only the first pass (i.e., PU level) of multi-pass DMVR is applied in reordering. When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

### Reordering Criterial

In the reordering process, a candidate is considered as redundant if the cost difference between a candidate and its predecessor is inferior to a lambda value e.g., |D1−D2|<λ, where D1 and D2 are the costs obtained during the first ARMC ordering and λ is the Lagrangian parameter used in the RD criterion at encoder side.

The algorithm according to ARMC-TM is defined as the following:
Determine the minimum cost difference between a candidate and its predecessor among all candidates in the list.
   If the minimum cost difference is superior or equal to λ, the list is considered diverse enough and the reordering stops.
   If this minimum cost difference is inferior to λ, the candidate is considered as redundant, and it is moved at a further position in the list. This further position is the first position where the candidate is diverse enough compared to its predecessor.
The algorithm stops after a finite number of iterations (if the minimum cost difference is not inferior to λ).

This algorithm is applied to the Regular, TM, BM and Affine merge modes. A similar algorithm is applied to the Merge MMVD and sign MVD prediction methods which also use ARMC for the reordering.

The value of λ is set equal to the λ of the rate distortion criterion used to select the best merge candidate at the encoder side for low delay configuration and to the value λ corresponding to another QP for Random Access configuration. A set of λ values corresponding to each signalled QP offset is provided in the SPS (Sequence Parameter Set) or in the Slice Header for the QP offsets which are not present in the SPS.

### Extension to AMVP Modes

The ARMC design is also applicable to the AMVP mode wherein the AMVP candidates are reordered according to the TM cost. For the template matching for advanced motion vector prediction (TM-AMVP) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

Note, when wrap around motion compensation is enabled, the MV candidate shall be clipped with wrap around offset taken into consideration.

### Multi-Hypothesis Prediction (MHP)

In the multi-hypothesis inter prediction mode (JVET-M0425), one or more additional motion-compensated prediction signals are signalled, in addition to the conventional bi-prediction signal. The resulting overall prediction signal is obtained by sample-wise weighted superposition. With the bi-prediction signal p_{bi} and the first additional inter prediction signal/hypothesis h₃, the resulting prediction signal p₃ is obtained as follows:

$${p}_{3} = ( 1 - α ) {p}_{b i} + α {h}_{3} \qquad ( 1 )$$

The weighting factor α is specified by the new syntax element add_hyp_weight_idx, according to the following mapping (Table 3):

TABLE 3
Mapping α to add_hyp_weight_idx

| add_hyp_weight_idx | α |
|---|---|
| 0 | ¼ |
| 1 | −⅛ |

The number of the additional prediction/hypothesis can be more than one. For example, the default addition hypothesis number in current ECM 4.0 (ECM is a video codec software repository for developing the latest video coding algorithm) is two. With the evolution of ECM software, MHP algorithm also evolves and becomes an algorithm super set of that in JVET-M0425. According to the MHP encoding flow of ECM 4.0, a single reference list is first constructed from reference list L0 and L1. With this step, only one reference index is required to be transmitted in the bitstream for decoding. Then the best results of the motion estimation from inter and affine search are put into a vector where possible candidates of adding additional hypothesis are stored. In the next step, in addition to the results from motion search, the inherited motion search results from different merge modes are also appended to the candidate vector. The motion information in these merge modes is inherited from the CU where motion searching is performed. With the collected candidates, the low complexity cost search can be invoked to seek most promising prediction units for coding. The candidates with lowest cost are then sent to high complexity search. The cost here means the SATD (sum of absolute Hadamard transformed difference) plus syntax bits multiplying the lambda (lambda is the factor to transform the bits to distortion domain widely used in rate distortion optimization in video codecs). If MHP is the best coding mode for this CU after competing with other coding modes, MHP will be the final coding mode selected for the CU. There are two types of search, “merge search” and “AMVP (advanced motion vector prediction) search” to be applied for seeking the additional hypothesis. In “Merge search”, possible candidates are those constructed by GPM (geometric partition mode, default number is 10). Every candidate is checked and if the cost after blending the new candidate is reduced, the candidate is appended to an output vector. In “AMVP search”, only two candidates are constructed as the predictor for motion vector. Motion estimation is invoked for searching the best motion vector for the relating prediction to well fit the residue. The residue is calculated as the original pixels subtracting the latest prediction of MHP (if there have been any existing additional hypotheses, these hypotheses should be blended as prediction to form the latest prediction).

### Merge Mode

To increase the coding efficiency of motion vector (MV) coding in HEVC, HEVC has Skip and Merge modes. Skip and Merge modes obtain the motion information from spatially neighbouring blocks (spatial candidates) or a temporal co-located block (temporal candidate). When a PU is Skip or Merge mode, no motion information is coded, instead, only the index of the selected candidate is coded. For Skip mode, the residual signal is forced to be zero and not coded. In HEVC, if a particular block is encoded as Skip or Merge, a candidate index is signalled to indicate which candidate among the candidate set is used for merging. Each merged PU reuses the MV, prediction direction, and reference picture index of the selected candidate.

For Merge mode in HM-4.0 in HEVC, as shown in FIG. 6, up to four spatial MV candidates are derived from A0, A1, B0 and B1, and one temporal MV candidate is derived from T_{BR} or T_{CTR} (T_{BR} is used first, if T_{BR} is not available, T_{CTR} is used instead). Note that if any of the four spatial MV candidates is not available, the position B2 is then used to derive another MV candidate as a replacement. After the derivation process of the four spatial MV candidates and one temporal MV candidate, removing redundancy (pruning) is applied to remove redundant MV candidates. If after removing redundancy (pruning), the number of available MV candidates is smaller than five, three types of additional candidates are derived and added to the candidate set (candidate list). The encoder selects one final candidate within the candidate set for Skip or Merge modes based on the rate-distortion optimization (RDO) decision, and transmits the index to the decoder.

Hereafter, we will denote the skip and merge mode as “merge mode”, that is, when we say “merge mode” in the later paragraph, we mean both skip and merge mode.

### Filtered Intra Block Copy (FIBC)

In JVET-AD0217 (Hong-Jheng Jhu, et. al., “Non-EE2: Filtered Intra Block Copy (FIBC)”, Joint Video Experts Team (JVET) of ITU-T SG 16 WP 3 and ISO/IEC JTC 1/SC 29, 30th Meeting, Antalya, TR, 21-28 Apr. 2023, Document: JVET-AD0217), filtered Intra Block Copy (FIBC) mode is disclosed where the prediction samples of the IBC are enhanced by applying a regression-model filter. The proposed filter consists of five spatial terms and one bias term. The filter coefficients are derived via the regression-model-based minimization of the difference between the template samples and their corresponding reference samples.

IntraTMP with Multi-Modes

In JVET-AD0194 (Po-Han Lin, et. al., “EE2-1.19: IntraTMP with multiple modes”, Joint Video Experts Team (JVET) of ITU-T SG 16 WP 3 and ISO/IEC JTC 1/SC 29, 30th Meeting, Antalya, TR, 21-28 Apr. 2023, Document: JVET-AD0194), IntraTMP with multiple modes is proposed. When IntraTMP is enabled, multiple template type (L-shape, left and above) are used to derive the template matching candidates and these candidates can be further fused using regression-model combination.

### Cross-Component Residual Model (CCRM) for Inter Prediction

In JVET-AD0108 (Pekka Astola, et. al., “AHG12: Cross-component residual model (CCRM) for inter prediction”, Joint Video Experts Team (JVET) of ITU-T SG 16 WP 3 and ISO/IEC JTC 1/SC 29, 30th Meeting, Antalya, TR, 21-28 Apr. 2023, Document: JVET-AD0108), the contribution proposes to apply a cross-component residual model (CCRM) based chroma prediction to improve compression efficiency of inter slices in ECM. The proposed method uses 8-tap convolutional filter to map reconstructed luma into an improved chroma prediction when the CCRM prediction mode is activated by a TU level flag. The input to the filter consists of 6 spatial luma samples, a non-regression-model term, and a bias term. Filter coefficients are derived in step 720 for each block separately using the prediction signals (i.e., predY 710, predCb 712 and predCr 714) and the filters are applied to the reconstructed luma signal in step 730. The reconstructed luma signal is formed by combining the luma prediction (PredY) 710 and residual luma signal (resY) using an adder 722. After applying the filters, the step 730 generates filtered-predicted Cb 740 and filtered-predicted Cr 750. The reconstructed Cb signal is formed by combining the filtered-predicted Cb 740 and residual Cb signal (i.e., resCb) using an adder 742. Similarly, the reconstructed Cr signal is formed by combining the filtered-predicted Cr 750 and residual Cr signal (i.e., resCr) using an adder 752.

### IBC Architecture in VVC

The effective reference area for intra block copy (IBC) in the HEVC SCC extensions is almost the whole already reconstructed area of the current picture, with some exceptions for parallel processing purposes. A drawback of the concept in HEVC is the requirement for additional memory in the DPB (Decoded Picture Buffer), for which hardware implementations usually employ external memory.

In VVC, only the Coding Tree Unit (CTU) to the left of the current CTU served as the reference sample area at the beginning of the current CTU's reconstruction process. VVC uses a fixed memory that can realize on-chip storage for IBC, which significantly decreases the complexity of implementing IBC in hardware architectures. FIG. 8. illustrates the IBC concept in HEVC and VVC, where each square shape corresponds to a coding tree unit (CTU). The grey-shaded area 840 denotes the already coded region, whereas the white area denotes the upcoming coding region. IBC in HEVC allows the grey-shaded region usage except for the two CTUs 850 on the right above the current CTU for allowing Wavefront Parallel Processing (WPP). For example, the current block 810 may point to reference block 820 based on BV 822 in HEVC. On the other hand, IBC in VVC only allows the CTU to the left of the current CTU as the reference area, denoted by the dotted frame 860. For example, the current block 810 may point to reference block 830 based on BV 832 in VVC.

### Syntax and Semantics

The IBC architecture in VVC forms a dedicated coding mode, where the IBC mode is the third prediction mode besides the intra and inter prediction modes. The bitstream carries the IBC syntax element indicating the IBC mode for a coding unit when the block size is 64×64 or less. Consequently, the largest CU size that can utilize IBC is 64×64. However, the reference sample addressing mechanism remains the same as in the HEVC SCC extensions by denoting a two-dimensional offset and reusing the inter prediction's vector coding processes. Another special case occurs when the chroma separate tree (CST) is active, where the coder cannot derive chroma BVs from the luma BVs, resulting in the usage of IBC for the luma coding block only.

### Reference Area and Sample Memory

The IBC design in VVC employs a fixed memory size of 128×128 for each colour component for storing the reference samples. Note that the maximum CTU size in VVC is also 128×128, i.e., the Reference Sample Memory (RSM) can hold samples of a single CTU when the maximum CTU size configuration is equal to 128×128. Note that the RSM may contain more than a single left-neighbouring CTU when the maximum CTU size is less than 128×128, resulting in the usage of multiple left-neighbouring CTUs. For example, when the maximum CTU size is equal to 32×32, the RSM may hold the samples of 15 left-neighbouring CTUs.

### JVET-AC0193 Non-EE2: Copy-Padding for IBC

In IBC mode, a Block Vector (BV) is used to indicate the displacement from the current block to a reference block, which must be already fully reconstructed inside the current picture. The reference block cannot be overlapped with the current block.

In JVET-AC0193 (Na Zhang, et. al., “Non-EE2: Copy-Padding for IBC”, Joint Video Experts Team (JVET) of ITU-T SG 16 WP 3 and ISO/IEC JTC 1/SC 29, 29th Meeting, by teleconference, 11-20 Jan. 2023, Document: JVET-AC0193), copy-padding can be applied on the overlapped area. With copy-padding, an unreconstructed sample in the overlapped region can be padded by copying its prediction sample, as shown in FIG. 9A and FIG. 9B, in an equation way,

$${P}^{′} ( x , y ) = P ( x + BVx , y + BVy )$$

wherein P′(x,y) is a padded sample at position (x, y), P(x+BVx, y+BVy) is a prediction sample, and (BVx, BVy) is the BV of current block. FIG. 9A illustrates an example where the current block 920 is overlapped with a reference block 910. The overlapped area is shown as a dot-filled area. In the conventional approach, the samples in the overlapped area are not reconstructed yet and are considered as unavailable. According to JVET-AC0193, the samples in the overlapped area can be padded by copying the prediction samples is corresponding location as shown in FIG. 9B, where samples a, b, c, e, f and g in the overlapped area of the reference block are padded by copied from corresponding predicted samples of the current block.

Copy-padding is performed only if the horizontal BV component is smaller than or equal to 0 and the vertical BV component is smaller than or equal to 0.

In the present invention, methods and apparatus to improve the coding performance for IBC mode are disclosed.

### BRIEF SUMMARY OF THE INVENTION

A method and apparatus for video coding using IBC mode or IntraTMP mode are disclosed. According to the method, input data associated with a current block in a current picture are received, wherein the input data comprise pixel data to be encoded at an encoder side or data associated with the current block to be decoded at a decoder side. A first predictor or a first hypothesis is derived by using a first prediction mode comprising IBC (Intra Block Copy) prediction mode or IntraTMP (Intra Template Matching Prediction) mode, wherein the IBC prediction mode derives the first predictor or the first hypothesis by locating a target reference block in a same picture as the current picture according to a first block vector, or the IntraTMP mode derives the first predictor or the first hypothesis according to a template matching cost between a reference template of the target reference block and a current template of the current block. A second predictor is derived. A blended predictor is derived by blending the first predictor or the first hypothesis with the second predictor. The current block is encoded or decoded by using a predictor candidate set comprising the blended predictor.

In one embodiment, the first predictor or the first hypothesis is generated by IBC AMVP mode or IBC merge mode. In another embodiment, the first predictor or the first hypothesis is generated by multiplying a first IBC predictor in IBC AMVP mode and a second IBC predictor in IBC merge mode with weighting.

In one embodiment, multiple first predictors or multiple first hypotheses are generated. In one embodiment, redundancy check is performed when the multiple first predictors or the multiple first hypotheses are generated.

In one embodiment, the first prediction mode comprises IBC merge mode, IBC AMVP mode, IBC GPM mode, IBC-CHIP mode, RRIBC mode, IBC-TM-inter mode, IBC-TM-merge mode, IBC-regular-merge mode, IBC-MBVD-merge mode, IBC-LIC mode, IBC-subblock mode, or a combination thereof. In one embodiment, the second predictor is derived using a second prediction mode and second prediction mode comprises IBC merge mode, IBC AMVP mode, IBC GPM mode, IBC-CIIP mode, RRIBC mode, IBC-TM-inter mode, IBC-TM-merge mode, IBC-regular-merge mode, IBC-MBVD-merge mode, IBC-LIC mode, IBC-subblock mode, or a combination thereof.

In one embodiment, the first prediction mode corresponds to IBC with bi-prediction. In one embodiment, a first BV (Block Vector) is derived by applying an IBC search algorithm and is used to locate a first referenced block for deriving a search pattern of a second BV. In one embodiment, BVDs (BV Differences) and BVPs (BV Predictions) related to the bi-prediction are signalled or parsed from a bitstream comprising coded data of the current block.

In one embodiment, a first BVD associated with a first BV of the bi-prediction is signalled or parsed from a bitstream comprising coded data of the current block, and a second BVD associated with a second BV of the bi-prediction is inferred to be 0.

In one embodiment, a merge index is signalled or parsed from a bitstream comprising coded data of the current block to indicate a target merge candidate from an IBC merge list being used for the bi-prediction.

In one embodiment, a flag is signalled or parsed from a bitstream comprising coded data of the current block to indicate whether the IBC AMVP mode is used for the bi-prediction.

In one embodiment, if the current block is coded in the IBC AMVP mode, all candidates in an AMVP candidate list for the current block are bi-predictive motions.

In one embodiment, if the current block is coded in the IBC AMVP mode, a leading BV of the current block is used to derive propagation intra mode.

In one embodiment, when a current slice type for the current block is an I-slice, the blended predictor is generated by one IBC AMVP predictor and one IBC merge predictor. In one embodiment, when a current slice type for the current block is a non-I-slice, the blended predictor is generated by blending one IBC AMVP predictor and one inter merge predictor, or is generated by blending one inter-AMVP predictor and one IBC merge predictor.

According to another method, a first predictor is derived by using IBC (Intra Block Copy) prediction mode or an inter prediction mode, wherein the IBC prediction mode corresponds to IBC AMVP (Advanced Motion Vector Prediction) mode or IBC merge mode, and wherein the first predictor is derived by locating a target reference block in a same picture as the current picture according to a first block vector selected from an IBC merge list or derived by a search pattern of IBC AMVP mode when the IBC prediction mode is used. A second predictor is derived according to an intra prediction mode. A blended predictor is derived by blending the first predictor with the second predictor. The current block is encoded or decoded by using a predictor candidate set comprising the blended predictor, wherein one or more processes and/or one or more conditions associated with said deriving the second predictor, said deriving the blended predictor or both are aligned for the inter prediction mode, the IBC AMVP mode and the IBC merge mode.

In one embodiment, said one or more processes and/or said one or more conditions comprise intra list construction.

In one embodiment, said one or more processes and/or said one or more conditions comprise blending weightings design.

In one embodiment, said one or more processes and/or said one or more conditions are related to PDPC (Position Dependent Prediction Combination).

In one embodiment, said one or more processes and/or said one or more conditions comprise deblocking filtering.

In one embodiment, said one or more processes and/or said one or more conditions comprise one or more constraints related current block size.

In one embodiment, said one or more processes and/or said one or more conditions comprise motion referring by other blocks.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of search area used for Intra Template Matching Prediction.

FIG. 3 illustrates an example of CPR (Current Picture Referencing) compensation, where blocks are predicted by corresponding blocks in the same picture.

FIG. 4A illustrates an example of BV adjustment for horizontal flip.

FIG. 4B illustrates an example of BV adjustment for vertical flip.

FIG. 5 illustrates an example of templates used for the current block and corresponding reference blocks to measure matching costs associated with merge candidates.

FIG. 6 illustrates the neighbouring blocks used for deriving spatial merge candidates for HEVC.

FIG. 7 illustrates a system block diagram of cross-component residual model (CCRM) for inter prediction.

FIG. 8. illustrates the IBC concept in HEVC and VVC, where each square shape corresponds to a coding tree unit (CTU).

FIG. 9A illustrates an example where the current block is overlapped with a reference block, where the samples in the overlapped area are not reconstructed yet and are considered as unavailable in the conventional approach.

FIG. 9B illustrates an example according to JVET-AC0193, where the samples in the overlapped area can be padded by copying the prediction samples in corresponding locations.

FIG. 10 illustrates a flowchart of an exemplary video coding system that uses blended IBC prediction mode according to an embodiment of the present invention.

FIG. 11 illustrates a flowchart of an exemplary video coding system that uses IBC-CIIP prediction mode aligned among IBC AMVP mode, IBC merge mode and inter mode according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the performance related to IBC mode, various methods are disclosed.

### Increase the Variation of IBC Blending Modes (IBC-CIIP)

In one embodiment, combined IBC mode can generate the final predictor by blending two IBC merge predictors. For example, one predictor can be generated according to the BV of the left neighbour. The other predictor can be generated according to a historical BV. After that, these two predictors are blended to generate IBC-CIIP final predictor. In another embodiment, combined IBC mode can generate the final predictor by blending one IBC merge predictor and one IntraTMP predictor. In one embodiment, combined IBC mode can generate the final predictor by blending one IBC AMVP predictor and one IntraTMP predictor.

In another embodiment, the blending weightings are designed based on the type of two predictors. For example, the first predictor is derived from the BV of the neighbouring block, and the second predictor is derived based on non-adjacent candidate. During blending, the first predictor will apply larger weighting than the second predictor. In another embodiment, the blending weightings are designed based on the template matching cost. For example, the blending weight can be larger for the predictor with a lower template matching cost.

In another embodiment, the blending weightings are designed based on the BVs and/or the prediction modes of neighbouring CUs. For example, the blending weight of IBC predictor can be larger if the top and left CUs are coded by IBC mode. On the other hand, the blending weight of intra predictor can be larger if the top and left CUs are coded by intra mode.

In another embodiment, the blending weightings are designed based on the DIMD gradient amplitudes in the neighbouring region (e.g., 3 template lines). For example, the blending weight of intra predictor can be larger if the DIMD gradient amplitude of the selected intra prediction mode is largest.

In another embodiment, the blending weightings (denoted as ω₀ and ω₁) are derived by regression model that minimizes the MSE between the blended template samples and the current template samples.

In one example, a blended template sample consists of K₀ (e.g., 2) spatial gradients, K₁ (e.g., 2) location terms, a nonlinear term, and a bias term. That is,

$${S}_{blended}^{i} = {c}_{0}^{i} \times C + {c}_{1}^{i} \times G y + {c}_{2}^{i} \times G x + {c}_{3}^{i} \times Y + {c}_{4}^{i} \times X + {c}_{5}^{i} \times P + {c}_{6}^{i} \times B ,$$

$$where ,$$

$$Gx = ( 2 W + N W + S W ) - ( 2 E + N E + S E ) ,$$

$$Gy = ( 2 N + N W + N E ) - ( 2 S + S W + S E ) ,$$

$$P = ( {C}^{2} + ( 1 << ( bitDepth - 1 ) ) ) >> bitDepth ,$$

where X and Y are the vertical and horizontal relative locations, B is a midValue set to (1<<(bitDepth−1)).

In another example, a blended template sample consists of T (e.g., 5) spatial samples, a nonlinear term, and a bias term. That is,

$${S}_{blended}^{i} = {c}_{0}^{i} \times C + {c}_{1}^{i} \times N + {c}_{2}^{i} \times S + {c}_{3}^{i} \times E + {c}_{4}^{i} \times W + {c}_{5}^{i} \times P + {c}_{6}^{i} \times B ,$$

$$where ,$$

$$P = ( {C}^{2} + ( 1 << ( bitDepth - 1 ) ) ) >> bitDepth ,$$

and B is a midValue set to (1<<(bitDepth−1)).

### Increasing the Variation of IBC-GPM Modes

In another embodiment, the final predictor of IBC-GPM mode can be generated by combining two different IBC merge predictors. For example, one predictor can be generated according to the BV of the left neighbour. The other predictor can be generated according to historical BV. After that, these two predictors are combined to generate IBC-GPM final predictor. In another embodiment, the final predictor of IBC-GPM mode can be generated by combining one IBC AMVP predictor and one intra predictor. In another embodiment, the final predictor of IBC-GPM mode can be generated by combining one IBC AMVP predictor and one IntraTMP predictor.

In another embodiment, TM based reordering can be performed to reorder IBC-GPM partition group. In that, the more promising candidates' index can be further reduced to improve the coding efficiency.

In one embodiment, the final predictor of IBC-GPM mode can be generated by combining one IBC AMVP/Merge predictor and one inter predictor. The inter predictor can be regular merge, MMVD (i.e., Merge with Motion Vector Difference), TM merge, BM merge, CIIP (i.e., Combined Inter Merge/Intra Prediction), Affine merge/AMVP, SbtMVP or other inter modes.

In one embodiment, the blending width of the IBC-GPM can be determined by the RD cost and be signalled by bits explicitly. Or the blending width of the IBC-GPM can be determined by the TM/BM cost and derived implicitly at the decoder side. The number of blending width candidates can depend on the CU size, the prediction modes of two GPM parts or the blending width of the neighbouring GPM CUs. For example, if both GPM parts are IBC or IntraTMP mode, the blending width should be small.

In one embodiment, the blending widths of two IBC-GPM parts can be different and determined separately. For example, if an IBC-GPM CU is composed of one IBC predictor and one inter predictor, the blending width of IBC/IntraTMP part can be small and the blending width of inter part can be larger and selected from N blending width candidates.

In one embodiment, a joint IBC and regular merge candidate list is constructed, which includes original regular merge candidates and IBC candidates. The IBC-GPM predictor is generated by two merge predictors from the joint IBC and regular merge list, or one merge predictor from the joint list and the other predictor from intra prediction mode (IPM) candidate list or TM merge candidate list.

In one embodiment, the IBC-GPM mode can be viewed as an inter mode and share the same signalling syntax with inter GPM mode. The subblock motion vectors of the IBC-GPM CU will be determined according to the non-IBC part. For example, if an IBC-GPM CU is composed of one IBC predictor and one inter predictor, the subblock motion vectors of the entire CU are set the same as the inter predictor.

### Improve IBC-LIC Mode

In one embodiment, IBC-LIC mode can be enabled with RRIBC mode. In that, the templates of IBC-LIC shall be derived according to RRIBC's type. For example, if the horizontal flip is enabled, the templates of IBC-LIC shall be the samples on the right side of referenced block and the samples on the top of referenced block. For example, if vertical flip is enabled, the templates of IBC-LIC shall be the samples on the left side of referenced block and the samples on the bottom of referenced block.

IBC with MHP

In one embodiment, IBC predictor can be a prediction/hypothesis blending with other predictions. The IBC predictor can be generated by IBC AMVP mode or IBC merge mode.

In one embodiment, it is constrained that subblock based IBC mode cannot be an additional prediction/hypothesis blending with other predictions.

In one embodiment, multiple BVs or motion shifts are considered in IBC prediction mode or IntraTMP prediction mode. In one embodiment, multiple predictors are considered in IBC prediction mode or IntraTMP prediction mode. In one embodiment, there can be redundancy in the multiple predictors or the multiple BVs. For example, some predictors or BVs can be the same. In one embodiment, redundancy check will be performed during multiple predictor generation or multiple BV generation.

In one embodiment, a predictor in IBC prediction mode or IntraTMP prediction mode is combined with other predictors with weightings, where other predictors can be predictors in IBC prediction mode or IntraTMP prediction modes or predictors in other inter-prediction modes. In one embodiment, BV in IBC prediction mode or IntraTMP prediction mode is multiplied with other BVs with weightings, where other BVs can be BVs in IBC prediction mode or IntraTMP prediction modes or MVs in other inter-prediction modes.

In one embodiment, a predictor in IBC merge mode is multiplied with a predictor in IBC AMVP mode with weighting. In one embodiment, a predictor in IBC merge mode is multiplied with a predictor in IBC merge mode with weighting. In one embodiment, a predictor in IBC AMVP mode is multiplied with predictor in IBC merge mode with weighting. In one embodiment, a predictor in IBC AMVP mode is multiplied with a predictor in IBC AMVP mode with weighting.

In one embodiment, a predictor is one of the IBC modes, including but not limited to, IBC merge mode, IBC AMVP mode, IBC GPM mode, IBC-CIIP mode, RRIBC mode, IBC-TM-inter mode, IBC-TM-merge mode, IBC-regular-merge mode, IBC-MBVD-merge mode, IBC-LIC mode, IBC-subblock mode, and the predictor is multiplied with other predictors with weightings, which can be predictors in other IBC mode, including but not limited to, IBC merge mode, IBC AMVP mode, IBC GPM mode, IBC-CIIP mode, RRIBC mode, IBC-TM-inter mode, IBC-TM-merge mode, IBC-regular-merge mode, IBC-MBVD-merge mode, IBC-LIC mode, IBC-subblock mode or a combination thereof.

In one embodiment, predictor is one of the IBC modes, including but not limited to, IBC merge mode, IBC AMVP mode, IBC GPM mode, IBC-CIIP mode, RRIBC mode, IBC-TM-inter mode, IBC-TM-merge mode, IBC-regular-merge mode, IBC-MBVD-merge mode, IBC-LIC mode, IBC-subblock mode, and the predictor is multiplied with other predictors with weightings, which can be predictors in other non-IBC mode, for example, GPM mode, MMVD mode, MHP mode, affine mode, subblock mode, or translational inter-prediction mode.

In one embodiment, when predictor is in reconstruction-reordered mode, the predictor can only be multiplied with other reconstruction-reordered predictors.

In one embodiment, when predictor is in reconstruction-reordered mode, the predictor cannot be multiplied with other predictors.

In one embodiment, predictors in IBC mode or IntraTMP mode can only blend with the predictors in IBC mode or IntraTMP mode.

In one embodiment, predictors can only blend with the predictors in the same prediction modes. For example, inter-predictors blend with inter-predictors, and IBC-predictors or IntraTMP predictors blend with IBC-predictors or IntraTMP predictors.

In one embodiment, blending weightings will decrease when there are more predictors. For example, the first predictor will use the largest weighting, the second predictor will use the second largest weighting, and so on.

In one embodiment, blending weightings will increase when there are more predictors. For example, the first predictor will use the smallest weighting, the second predictor will use the second smallest weighting, and so on.

In one embodiment, blending weightings can be some fixed values.

In one embodiment, for those predictors to be blended, those predictors will be reordered based on some metrics first, such as template-matching costs, boundary matching costs, SSE, SATD, SAD, and then the reordered predictors are blended according to decreasing or increasing weightings.

IBC with NAMVP

In one embodiment, non-adjacent spatial candidates can be used in IBC merge. Only if the to-be referenced blocks are in the valid referenced region, they can be referenced. In one embodiment, the positions of non-adjacent candidates of IBC are designed related to the boundary position of the IBC's valid referenced region.

In one embodiment, the similarity check can be applied on NAMVP list derivation to increase the diversity of NAMVPs. The threshold of similarity check on NAMVP list can be different from IBC merge list. For example, a strict threshold (e.g. only if the to-be inserted candidate is N pixel far away from any other candidate in the list, it can be inserted to the list. N is an integer larger than zero) will be used during the NAMVP list generation. After that, the candidates in NAMVP list are inserted to IBC merge candidate list with loose threshold.

IBC with Diversity Reordering

In the reordering process, a candidate is considered as redundant if the cost difference between a candidate and its predecessor is inferior to a lambda value e.g. |D1-D2|<λ, where D1 and D2 are the costs obtained during the first ARMC ordering and 2 is the Lagrangian parameter used in the RD criterion at encoder side.

In one embodiment, if the reordering process is applied on IBC merge candidate list, the lambda value can be different from the lambda value used for inter merge candidate list. For example, lambda values used for IBC merge list are N times larger than lambda values used for inter merge candidate list. For another example, lambda values used for IBC merge list are lambda values used for inter merge candidate list with an offset added. For another example, lambda values used for IBC merge list can be derived by a linear function with lambda values used for inter merge candidate list. For another embodiment, the lambda values used for IBC merge list can be designed according to the current CU size, bits depth or picture resolution.

### Bi-Predictive IBC AMVP Mode

In the current IBC design, IBC-coded blocks only need to signal one block vector (BV) to reference a previously coded block in the current picture. To further improve the IBC mode, a bi-predictive IBC AMVP mode is proposed.

In one embodiment, the first BV is derived by applying IBC's search algorithm (i.e., IBC hash search or IBC motion estimation). After that, the referenced block of the first derived BV will be used to derive a search pattern of the second BV. For example, the search pattern of the second BV can be two times of the original block minus the referenced block of the first derived BV.

In another embodiment, the BVD of the first BV and the second BV are both signalled in the bitstream for the first BV and the second BV respectively.

In another embodiment, the BVP of the first BV and the second BV can be different, and two BVP indexes are signalled in the bitstream for the first BV and the second BV respectively. In another embodiment, the BVP of the first BV and the second BV are the same. In this case, only one BVP index is signalled in the bitstream, and it will be shared by the first BV and the second BV.

In another embodiment, a BVD is signalled in the bitstream to indicate the first BV. Besides, a second BVD is signalled in the bitstream to indicate the difference between the first BVD and the second BVD. The final second BVD can be derived by adding the signalled BVD difference and the first BVD. In another embodiment, a BVD is signalled in the bitstream to indicate the first BV. In addition, an index is signalled in the bitstream to indicate the BVD difference between the first BVD and the second BVD. The final BVD difference between the first BVD and the second BVD can be derived by a pre-defined LUT (Look-up Table) and the signalled index. In another embodiment, a BVD is signalled in the bitstream to indicate the first BV. In addition, an index is signalled in the bitstream to indicate the BVD difference (BVDd) between the first BVD and the second BVD. The signalled index can be used to derive BVDd's direction and distance. In another embodiment, a BVD is signalled in the bitstream to indicate the first BV and the second BVD will be inferred to be zero.

In another embodiment, after the first BV is derived, the search pattern of the second BV can be derived. The second BV is searched based on the derived search pattern and the search region is around the first BV. For example, the distance between the first BV and the second BV is constrained in N integer luma samples. N can be any integer larger than zero.

In another embodiment, the search region of the second BV around the first BV is designed based on the CU size, CU width, CU height, or current picture resolution. In another embodiment, the search region of the second BV around the first BV is designed corresponding to the motion resolution of the first BV. In another embodiment, the search region of the second BV can be around the best BVP candidate. The search region can be design based on the CU size, CU width, CU height, the motion resolution of the first BV, or current picture resolution.

In one embodiment, the first BV is referenced by an IBC merge candidate. After that, the referenced block of the first derived BV will be used to derive a search pattern of the second BV. For example, the search pattern of the second BV can be two times of original block minus the referenced block of the first derived BV. For example, a spatial candidate is referenced as the first BV. For another example, an HMVP candidate is referenced as the first BV.

In another embodiment, a merge candidate list is generated, and then TM reordering technology is applied to reorder the merge candidate list. By doing this, the merge index of promising candidates can be shorter.

In another embodiment, a merge index is signalled in the bitstream to indicate which merge candidate is used.

In one embodiment, after deriving the first predictor and the second predictor of IBC, a motion refinement technology is used to further refine the predictor. For example, DMVR technology, BDOF technology can be applied.

In one embodiment, the blending weight of the first predictor and the second predictor can be different. For example, the weighting pairs of the first predictor and the second predictor can be derived based on the TM cost.

For another example, the weighting pairs of the first predictor and the second predictor can be derived based on the BV cost. The referenced blocks far away from current block will apply lighter weights and the referenced blocks closer to current block will apply higher weights. For another example, the weighting pairs of the first predictor and the second predictor can be derived based on the referenced block type. For example, the referenced block derived from a merge candidate will apply lower weight than the block derived from the IBC searching process. For another example, the weighting pair can be signalled in the bitstream. For example, an index is signalled to indicate the value of the weighting pair.

In one embodiment, a flag is signalled in the bitstream to indicate the on-off of bi-predictive IBC AMVP mode. Only if bi-predictive IBC AMVP indication flag is true, the bi-predictive IBC AMVP mode related syntax will be signalled. For example, the syntax corresponds to merge_idx, or the BVP and BVD for the second BV.

In one embodiment, a high-level syntax flag is signalled in the bitstream to indicate the on-off of bi-predictive IBC AMVP mode. For example, the syntax corresponds to sps_bi_ibc_amvp_enabled_flag, pps_bi_ibc_amvp_enabled_flag, or ph_bi_ibc_amvp_enabled_flag. The on-off control of bi-predictive IBC AMVP mode is aligned with IBC fractional-pel enabling flag. They can be enabled in the same condition. For example, if the hash hit rate of current picture is low enough, bi-predictive IBC AMVP mode and IBC fractional-pel mode will be enabled.

In another embodiment, only if high-level syntax flag of bi-predictive IBC AMVP mode is true, lower level (i.e., CU level) syntax of bi-predictive IBC AMVP mode can be signalled.

In one embodiment, the inter direction index is used to indicate the on-off of bi-predictive IBC AMVP mode. For example, if bi-predictive IBC AMVP mode is enabled for the current block, inter direction index needs to be signalled and the inter direction index shall be set to 2. In one embodiment, the inter direction index is used to indicate the on-off of bi-predictive IBC AMVP mode and the context table for the inter direction index for IBC and non-IBC modes shall be different.

In one embodiment, the maximum predictive bin number of bi-predictive IBC AMVP mode can be different from the traditional uni-predictive IBC AMVP mode. For example, the maximum predictive bin number of bi-predictive IBC AMVP mode is aligned with non-IBC inter prediction mode.

In one embodiment, the BVD prediction of bi-predictive IBC AMVP mode can be aligned with the non-IBC inter prediction mode.

In one embodiment, the bi-predictive IBC AMVP mode cannot be enabled with IBC-CIIP, IBC-GPM, IBC-LIC. In one embodiment, the bi-predictive IBC AMVP mode can be enabled with IBC-CHIP, IBC-GPM, IBC-LIC.

In one embodiment, if a block is coded by the bi-predictive IBC-AMVP mode, the first BVD is signalled as a motion from reference picture L0. The second BVD is signalled as a motion from reference picture L1. In that, no reference picture indexes need to be signalled.

In one embodiment, if a bi-predictive IBC-AMVP coded block is referenced as a merge candidate. Two BVs of the bi-predictive IBC-AMVP coded block will be used to generate the final predictor. In one embodiment, if a bi-predictive IBC-AMVP coded block is referenced as a merge candidate, the inherited weighting index will be used to derive the weighting pair for generating the final predictor. In one embodiment, if a block is coded by the bi-predictive IBC-AMVP mode, all candidates in BVP candidate list shall be bi-predictive motions. Otherwise, if a block is coded by the uni-predictive IBC-AMVP mode, all candidates in BVP candidate list shall be uni-predictive motions. In one embodiment, if a block is coded by the bi-predictive IBC-AMVP mode, only the first BV will be used to derive the propagation intra mode.

In one embodiment, during the motion pruning process, two motions of bi-predictive IBC-AMVP blocks will be used for comparison. For example, it is treated as different when one candidate is bi-predictive IBC-AMVP coded and the other candidate is uni-predictive IBC-AMVP coded. For another example, it is treated as different when two candidates are bi-predictive IBC-AMVP coded and either the first BV or the second BV of two candidates are different. In one embodiment, during the motion pruning process, if two candidates are bi-predictive IBC-AMVP coded blocks, not only the motion, but also the weighing index will be used for comparison.

In one embodiment, if a block is coded by the bi-predictive IBC-AMVP mode, in the deblocking stage, only the first BV will be used to derive the BS value. In one embodiment, if a block is coded by the bi-predictive IBC-AMVP mode, in the deblocking stage, only the second BV will be used to derive the BS value.

In one embodiment, if a block is coded by the bi-predictive IBC-AMVP mode, in the deblocking stage, the averaging of two BVs will be used to derive the BS value.

### Bi-predictive IBC Mode

In one embodiment, the current slice type can be considered when the bi-predictive IBC mode is performed.

In one embodiment, when the current slice type is I-slice, bi-predictive IBC-AMVP mode will blend one IBC AMVP predictor and one IBC merge predictor. When the current slice type is non-I-slice, bi-predictive IBC-AMVP mode will blend one IBC-AMVP predictor and one inter merge predictor. In that, the motion of an inter merge predictor doesn't need to be a motion pointing to a reference block in the current picture.

In one embodiment, when the current slice type is I-slice, bi-predictive IBC-AMVP mode will blend one IBC AMVP predictor and one IBC merge predictor. When the current slice type is a non-I-slice, the bi-predictive IBC-AMVP mode will blend one inter-AMVP predictor and one IBC merge predictor. In this case, the motion of an inter-AMVP predictor doesn't need to be a motion pointing to a reference block in the current picture. It can be a motion pointing to a reference block in any reference picture.

In one embodiment, the above-mentioned techniques can be applied to the IBC-CIIP mode. According to the current slice type, the IBC-CIIP mode can blend different kinds of predictors.

In one embodiment, when the current slice type is I-slice, the IBC-CIIP mode will blend one IBC merge predictor and one intra predictor. When the current slice type is a non-I-slice, the IBC-CIIP mode will blend one inter merge predictor and one IBC merge predictor. In this case, the motion of an inter merge predictor doesn't need to be a motion pointing to a reference block in the current picture.

In one embodiment, when blending one IBC predictor and one inter merge predictor, equal weighting pair will be applied. In one embodiment, when blending one IBC predictor and one inter merge predictor, the weights for inter merge predictor will be larger than the weights for IBC predictor. In one embodiment, when blending one IBC predictor and one inter merge predictor, the weights for the inter merge predictor will be smaller than the weights for the IBC predictor. In one embodiment, when blending one IBC predictor and one inter merge predictor, if the IBC predictor is derived from the IBC AMVP mode, the weights for IBC predictor will be larger than the weights for the inter merge predictor.

In one embodiment, when blending one inter-AMVP predictor and one IBC merge predictor, the weights for the inter-AMVP predictor will be larger than the IBC merge predictor.

In one embodiment, not only the slice type can be used to determine the to-be blending predictors, but other criteria can also be used.

In one embodiment, the criteria can be the syntax used to indicate whether the current slice tends to be a screen content. For example, if the slice is a non I-slice, it may be found that most of the parts in this slice is flat after analysing this slice, IBC merge predictor will be blended with IBC-AMVP predictor (like an I-slice behaviour). In one embodiment, the criteria can be the syntax used to indicate whether fractional MVDs are used in MMVD or IBC-MBVD. In one embodiment, the above-mentioned criteria can also be used to restrict the on-off of IBC with multiple hypothesis mode.

In one embodiment, if IBC with a multiple hypothesis mode of a slice/picture is not allowed, the related syntaxes don't need to be further signalled.

In one embodiment, two IBC merge predictors can be blended in the IBC merge MHP mode. In this case, the blending pairs are predefined. In one embodiment, in the IBC merge MHP mode, a CU-level on-off flag is signalled to indicate the on-off of this mode. After that, if the IBC merge MHP mode is enabled, an ibc_mhp_idx is signalled to further indicate which blending pair is used.

To further improve the coding efficiency of ibc_mhp_idx, the blending pairs in PredOList and Pred1List will be reordered, based on the TM cost. In this case, the more promising candidates will be assigned with smaller indexes.

In one embodiment, in I-slice, a syntax used to indicate the blending predictors type doesn't need to be signalled. In a non-I-slice, a syntax used to indicate the blending predictors type will be signalled.

In one embodiment, if IBC with multiple hypothesis predictors is not allowed in the current CU, a syntax used to indicate the blending predictor type doesn't need to be signalled.

In one embodiment, in an I-slice, a syntax used to indicate the to-be blending predictors is used to indicate an IBC predictor in the IBC merge list. In a non-I-slice, a syntax used to indicate the to-be blending predictors is used to indicate an inter predictor in inter merge list.

In one embodiment, a syntax is signalled to indicate whether IBC predictor can be used to combine with other non-IBC predictors.

In one embodiment, if a syntax is signalled to indicate that IBC predictor is used to combine with other non-IBC predictors, and merge_idx doesn't need to be signalled. It will be inferred to be zero.

In one embodiment, if a syntax is signalled to indicate that IBC predictor is used to combine with other non-IBC predictors, hyp_weight_idx used to indicate the blending weights doesn't need to be signalled. Equal weights will be inferred in blending or a pre-defined weight pair will be used.

IBC-CIIP mode

In one embodiment, the behaviour of inter-CIIP mode, IBC-CIIP in AMVP and IBC-CIIP in merge mode can be aligned.

In one embodiment, the behaviour can be the intra list construction. In one embodiment, the behaviour can be the blending weightings design. In one embodiment, the behaviour can be related to PDPC (Position Dependent Prediction Combination). The PDPC is an intra prediction mode that has been adopted by VVC. For VVC, PDPC is applied to the Planar, DC, horizontal, vertical intra modes, as well as to certain angular intra modes. When PDPC is applied, the prediction sample at a location is calculated as a combination of the current sample and two neighbouring reference samples, where one neighbouring sample is from an above neighbouring reference line and another neighbouring sample is from the left neighbouring reference line). In this case, both inter-CIIP mode and IBC-CIIP mode can support PDPC, or both inter-CIIP mode and IBC-CIIP mode cannot support PDPC. In one embodiment, the behaviour corresponds to deblocking filter when the current block is inter-CIIP mode or IBC-CIIP mode. In one embodiment, the behaviour can be the size constraints. For example, when the CU area is too large or too small, inter-CIIP and IBC-CHIP will be disabled. In one embodiment, the behaviour corresponds to motion referring by other CUs. For example, if a block is inter-CIIP mode or IBC-CIIP mode, its motion cannot be referenced by others. For another example, if a block is inter-CIIP mode or IBC-CIIP mode, its intra prediction cannot be referenced by others.

In one embodiment, IBC-CIIP can merge two IBC predictors. For example, blending one IBC TM merge predictor and one regular merge predictor.

In one embodiment, more than one bin is signalled to indicate the to-be blending predictor in IBC-CIIP. For example, the first bin is used to indicate the predictor's type (i.e., intra predictor or IBC predictor), and the second bin is used to indicate the predictor's index (i.e., 0 or 1).

In one embodiment, only one bin is signalled to indicate the to-be blending predictor in IBC-CIIP. For example, the bin is used to indicate the predictor's type (i.e., intra predictor or IBC predictor). In one embodiment, only one bin is signalled to indicate the to-be blending predictor in IBC-CHIP. For example, the bin is used to indicate the predictor's type (i.e., intra predictor or IBC predictor). The predictor's index is derived by implicit methods (i.e., the template matching related method). In one embodiment, more than one bin is signalled to indicate the to-be blending predictor in IBC-CIIP. For example, two bins are used and two separated context tables are used for the two bins. In one embodiment, more than one bin is signalled to indicate the to-be blending predictor in IBC-CIIP. For example, two bins are used. The first bin is coded by context coded bin, and the other bin is coded by EP bin.

In one embodiment, the syntax used to indicate the to-be blending predictor in IBC-CIIP is coded by unary code.

### IBC Merge List and Related Syntax Design

In the current IBC design, IBC includes IBC-merge coded type and IBC-AMVP coded type. In IBC merge mode, a neighbouring, historical, TMVP or non-adjacent spatial candidate will be inserted into an IBC merge candidate list. After that, a merge index will be signalled in the bitstream to indicate which merge candidate is used.

In IBC AMVP mode, a motion estimation process will be performed to determine a referenced BV and target BV's motion information will be directly signalled in the bitstream.

In one embodiment, it is proposed to add an IBC-merge regression-model-filtering mode.

For example, the regression-model filter can be a linear model, a non-linear model, or a gradient linear model, which uses gradient values to derive the model's parameters, or a cross component linear model.

In one embodiment, a list will be generated for IBC-merge regression-model-filtering mode. Each candidate in the list will be refined by applying a regression-mode filtering. For example, the filter coefficients are derived via the regression-model-based minimization of the difference between the template samples of the current block and their corresponding reference samples.

Regarding the syntax design, in one embodiment, a flag is signalled in the bitstream to indicate the on-off of IBC-merge regression-model-filtering mode. If the flag is true (i.e., IBC-merge regression-model-filtering mode is enabled), a merge index will be further signalled in the bitstream to indicate which IBC-merge regression-model-filtering candidate is used.

In one embodiment, a list will be generated for IBC merge mode. After that, each candidate will be tested with regression-model filtering or without regression-model filtering. The best type will be selected.

Regarding a syntax design, in one embodiment, a merge index will be signalled in the bitstream to indicate which candidate in IBC merge list is used. After that, a regression-model filtering on-off flag will be further signalled to indicate whether regression-model filtering will be applied or not.

In one embodiment, a list will be generated for IBC merge mode. After that, each candidate will be inserted into the candidate list again by interleaving. For example, the candidates with odd index will perform regression-model filtering and the candidates with even index will not perform regression-model filtering.

In one embodiment, the non-regression-filtered candidates and regression-filtered candidates can be mixed together (e.g. interleaved or reordered by some cost) in one list. For example, TM cost is used to reorder the candidates. For another example, the BV cost is used to reorder the candidates.

Regarding a syntax design, in one embodiment, a merge index will be signalled in the bitstream to indicate which candidate in IBC merge list is used. After that, based on the signalled index, the decoder can know whether to perform regression-model filtering or not.

In another embodiment, in the previously mentioned embodiment, all candidates in the second round can also be inserted at the end of IBC merge list.

In one embodiment, a list will be generated for IBC merge mode. After that, apply TM-based reordering for the generated list. Only the first N candidates in the reordered list can perform regression-model filtering.

Regarding the syntax design, in one embodiment, a merge index will be signalled in the bitstream to indicate which candidate in IBC merge list is used. After that, if the signalled merge index is smaller than N, a regression-model filtering on-off flag will be further signalled to indicate whether regression-model filtering will be applied or not.

In one embodiment, a list will be generated for IBC merge mode. After that, TM-based reordering is applied to the generated list. If a candidate's TM cost is larger than a threshold, regression-model filtering will be performed.

Regarding the syntax design, in one embodiment, a merge index will be signalled in the bitstream to indicate which candidate in IBC merge list is used. After that, if the TM cost of a target candidate is larger than a threshold, a regression-model filtering technique will be performed implicitly.

In one embodiment, the regression-model filtering technique is exclusive with IBC-LIC. In one embodiment, the regression-model filtering technique is exclusive with RRIBC. In one embodiment, the parameters derived for regression-model filtering can be used to define

IBC-LIC's parameters.

In one embodiment, the neighbouring samples used for regression-model filter's parameters derivation shall be determined according to RRIBC type. For example, if RRIBC is horizontal flip type, the samples on the top and right of the reference block will be used. If RRIBC is vertical flip type, the samples on bottom and left of the reference block will be used.

In one embodiment, it is proposed to add an IBC-merge multi-modelling mode.

In one embodiment, a list will be generated for IBC-merge multi-modelling mode including motions referenced at T pre-defined positions. T can be any integer larger than zero. For example, the pre-defined positions are designed according to CU width and CU height. After that, TM-based reordering will be performed by comparing the top-template of the referenced block and the top-template of the current block. The first N candidates with lowest TM costs will be kept. Then, a TM-based reordering will be performed again by comparing the left-template of the referenced block and the left-template of the current block. The first M candidates with lowest TM costs will be kept. Then a TM-based reordering will be performed again by comparing the top and left-template of the referenced block and the top and left-template of the current block. The first K candidates with lowest TM costs will be kept.

In one embodiment, the list will be reordered based on the TM cost. In one embodiment, the final BV can be any of the candidates in the list. In one embodiment, the final BV can be an averaging BV derived from top N candidates in the list. In one embodiment, the final predictor can be an averaging of N predictors generated by N candidates in the list. N can be any integer value larger than 0.

Regarding the syntax design, in one embodiment, a flag is signalled in the bitstream to indicate the on-off of IBC-merge multi-modelling mode. If the flag is true (i.e., IBC-merge-multi-modelling mode is enabled), a merge index will be further signalled in the bitstream to indicate which IBC-merge-multi-modelling candidate is used.

Regarding the syntax design, in one embodiment, a flag is signalled in the bitstream to indicate the on-off of IBC-merge-multi-modelling mode. If the flag is true (i.e., IBC-merge-multi-modelling mode is enabled), a merge index will be further signalled in the bitstream to indicate which combination shall be used to generate the final predictor.

In one embodiment, in a single tree, for an IBC coded block, if luma is coded by IBC, chroma can only be coded by IBC. The above-mentioned regression-model filtering method can be applied to refine chroma predictors.

In one embodiment, the neighbouring samples of a luma block and the neighbouring samples of a chroma block can be used to derive a regression-model model. After that, the regression-model model can be applied to further refine chroma predictors after a chroma predictor is derived based on scaled luma's BV.

Regarding the syntax design, in one embodiment, a flag is signalled in the bitstream to indicate the on-off of IBC chroma refinement. In another embodiment, if the CU size is satisfied some conditions, the IBC chroma refinement will be always applied without signalling.

The above-mentioned refinement methods can also be applied to screen content related tools (e.g. modes that use current picture as the reference picture).

### Directly Referencing Mode for Intra Chroma Prediction

In this invention, an intra chroma mode is proposed which utilizes a BV-referenced chroma mode for generating the prediction. The BV-referenced chroma mode mentioned here is the chroma mode of the reference block corresponding to the BV obtained in the intra luma prediction.

In one embodiment, if the current block is coded by the proposed intra chroma mode, the prediction of the current block can be generated by directly applying the BV-referenced chroma mode to the L-shape neighbouring reference sample of the current block. For example, if the BV-referenced chroma mode is a planar mode, the chroma prediction of the proposed chroma mode is generated by applying the planar mode to the L-shape neighbouring reference samples of the current block.

In another embodiment, if the current block is coded by the proposed intra chroma mode, the prediction of the current block could be a fusion of the prediction generated by BV-referenced chroma mode and the prediction generated by another predefined intra chroma mode. The fusion weight could be a predefined weight set or obtained by minimizing MSE on the neighbouring template.

In another embodiment, if the current block is coded by the proposed intra chroma mode, the prediction of the current block can be a fusion of the predictions generated by BV-referenced chroma mode and the reference block corresponding to the BV obtained in the intra luma prediction. The fusion weight can be a predefined weight set or obtained by minimizing MSE on the neighbouring template.

In one embodiment, if the luma component of the current block is coded by one or a subset of BV-related coding tools (e.g., IntraTMP mode or IBC mode), a flag can be signalled to indicate whether the proposed chroma mode is used to encode the chroma component of the current block or not. If this flag is false, the method falls back to the original intra chroma coding.

In one embodiment, if the collocated luma block of the current chroma block is coded in BV-related coding tools, the proposed fusion will be applied automatically with some constraints. For example, if the current block size is smaller than or larger than a pre-defined threshold, the proposed fusion will be applied. In this case, no additional flag needs to be signalled to indicate the on-off of the proposed fusion mode.

In one embodiment, when the proposed fusion mode is applied, the chroma predictor will be fused with the reference block pointed by the BV and the target fusion BV can be dependent on the luma BV.

In one embodiment, when the proposed fusion mode is applied, the chroma predictor will be fused with the reference block pointed by the BV and the target fusion BV can be dependent on the luma BV. The weightings of two predictors can be determined by some costs (e.g. TM cost). For another embodiment, sample-based weighting can be used. For the samples near the boundary, larger weights will be applied to the predictor generated by intra mode. Otherwise, larger weights will be applied to the predictor pointed by luma BV.

In one embodiment, a high-level syntax can be signalled in SPS, PPS (Picture parameter Set), PH (Picture header) or SH (Slice Header) to indicate if the proposed chroma mode is allowed for the current sequence, picture, or slice.

In one embodiment, the previously mentioned high-level syntax can only be signalled when BV-related coding tool (e.g., IntraTMP mode or IBC mode) are both on or at least one of them is on.

### Chroma Mode Coding Improvement

Since blocks with complicated textures may be difficult to encode by regular intra modes, if the neighbouring region has similar textures as the current block, IntraTMP mode may be more suitable than other regular intra luma modes. At this time, the cross-component prediction modes may also be more suitable than other regular intra chroma modes.

In this invention, a method is proposed which prefers selecting cross-component prediction modes when the coded intra luma mode is BV-related coding tools (e.g., IntraTMP mode or IBC mode).

In one embodiment, there can be additional context model for coding the intra chroma LM flag, and the selection of multiple context models could depend on whether the luma component of the current block is coded by one or a subset of BV-related coding tools (e.g., IntraTMP mode or IBC mode) or not.

In one embodiment, if the luma component of the current block is coded by one or a subset of BV-related coding tools, the intra chroma LM flag cannot be signalled and the chroma mode can be inferred as one of the cross-component prediction modes.

In one embodiment, the syntax order or chroma mode candidate order can be adaptively changed depending on whether the collocated luma block is coded in BV-related coding tools.

According to JVET-AC0193, when the prediction and the reference IBC blocks overlap, cost in the TM-related tools which may be interacting with IBC (e.g. TM_AMVP, TM_MRG, IBC_TM, IBC_BVD, IBC_MRG, etc) is adjusted using a cost factor, as shown below with a fixed IBC_OVERLAP_TM COST FACTOR=2.5:

if (((xBv + nwidth) >=1 && ((yBv + nHeight) >= 1))
{
uiCost = (unit64_t)(uiCost * IBC_OVERLAP_TM_COST_FACTOR);
}

In one method, the IBC_OVERLAP_TM_COST_FACTOR is not a fixed value, but can have multiple values. In one embodiment, the value of the cost factor can be obtained based on the size of the overlapped area. In one embodiment, there are multiple pre-defined cost factors, and the one used for the current block is indicated at CU/PU/CTU/SH/PH/APS/SPS or other level) to the decoder or implicitly defined at the decoder (at CU/PU/CTU/SH/PH/APS/SPS or other level. In one embodiment, a subset of the cost factors from the predefined set is used. In one embodiment, the cost factor can be adjusted based on the tool/prediction method. In this case, a different cost factor is used for different tools. In one embodiment, the cost factor is adjusted based on the slice type (i.e., I/P/B). In one embodiment, the cost factor is adjusted based on the neighbouring information (e.g., coding/motion information of the neighbouring CUs). In one embodiment, multiple adjustment factors are combined. For example, factors are adjusted based on the slice type and on the neighbouring information.

In one method, when the prediction block is outside of the prediction area and padding needs to be used to fill in the unavailable prediction samples, those unavailable samples may not be precise enough. Therefore, those unavailable samples need to have a smaller “value” or “weight” (i.e., meaning be less important) when they are used for prediction. In one embodiment, such prediction blocks have one or more special adjustment factor(s) which are used to compensate the part of a non-precise prediction. In one embodiment, the cost factor is pre-defined, in another embodiment, this cost factor is signalled to the decoder at CU/PU/CTU/SH/PH/APS/SPS or other level.

In one method, cost factors are applied to adjust the cost not only in IBC-related tools but also other Intra and/or Inter tools. In one embodiment, the cost factor is used to adjust the cost of prediction in case if those tools are interacting with TM. In other words, whenever the tool is using the TM-related cost for adjusting the prediction cost, the TM-related cost will be modified by a factor, in order to adjust the priority of such prediction. In one embodiment, if a CU is predicted using one of the Inter prediction tools and the reference block overlaps with a current prediction block, additional weighting factor (one or more) can be applied, according to the overlapped area.

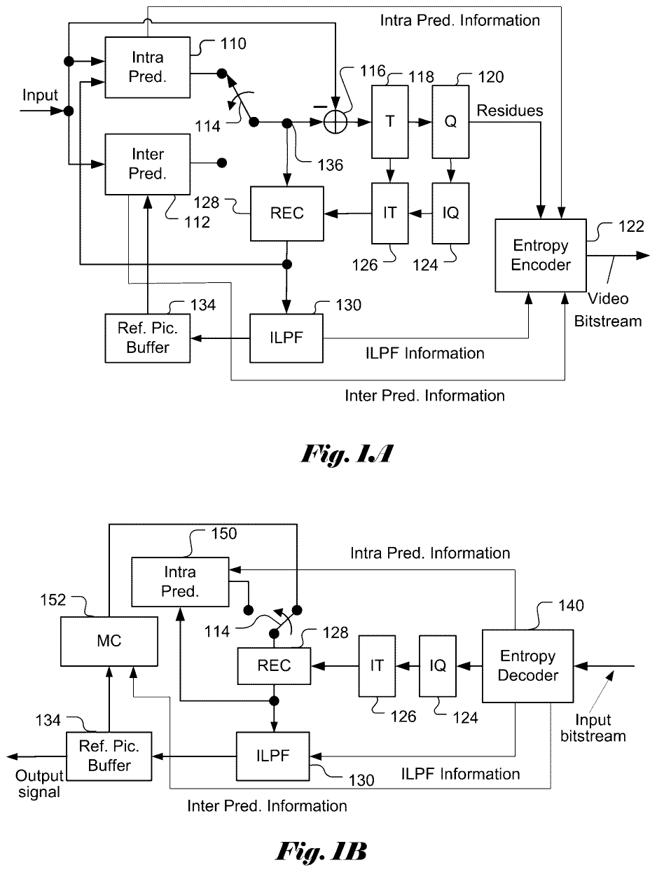

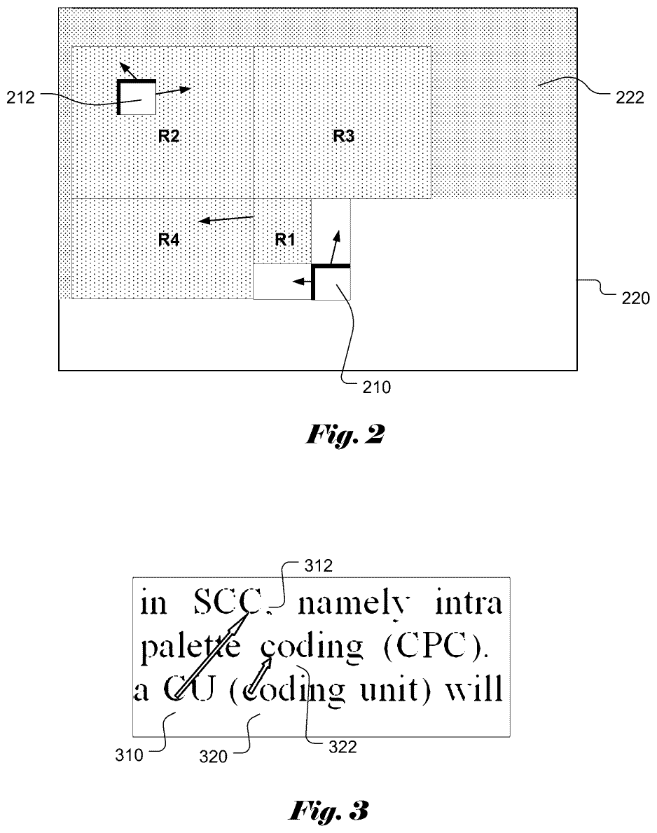

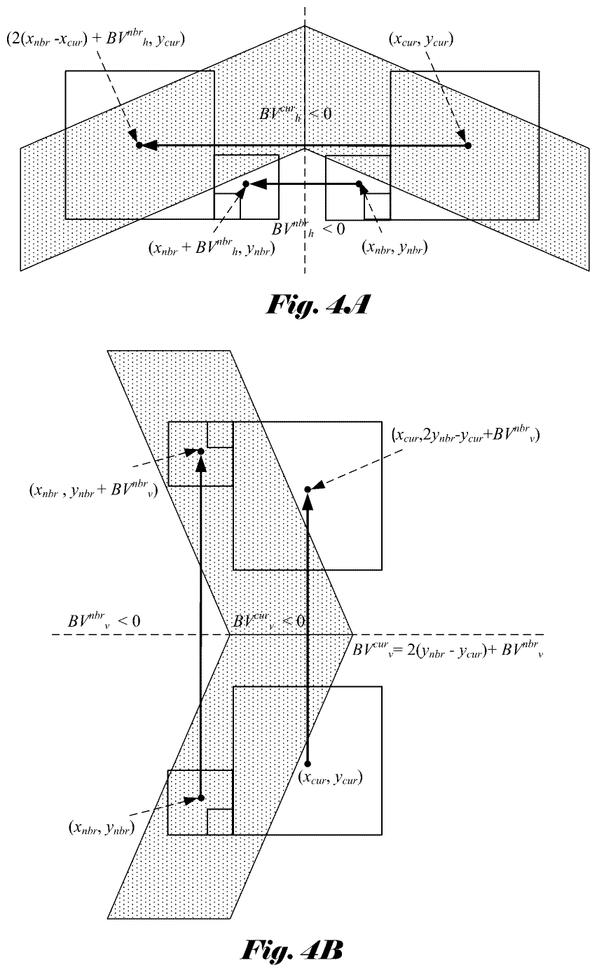

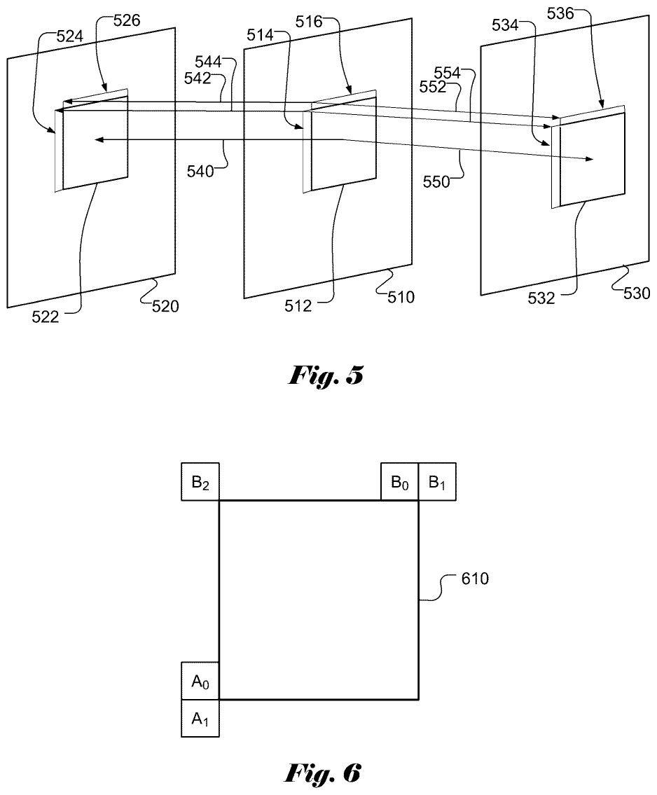

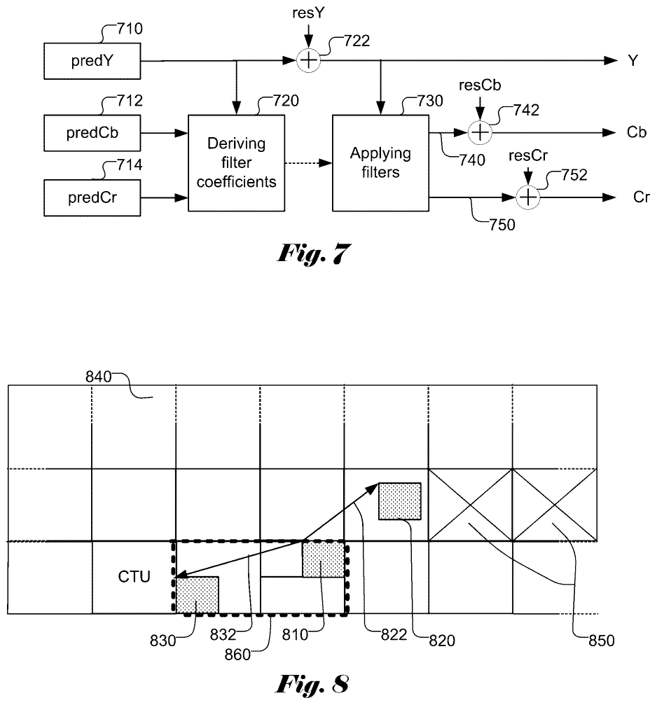

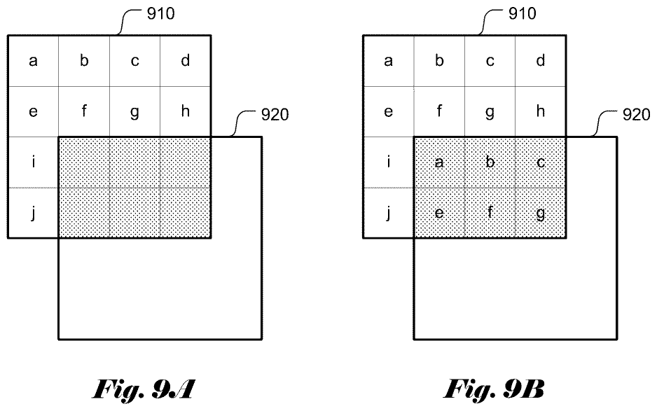

The blended IBC prediction mode and aligned bi-predictive IBC mode as described above can be implemented in an encoder side or a decoder side. For example, any of the proposed candidate derivation methods can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). However, the decoder or encoder may also use additional processing unit to implement the required IBC processing. While the Intra/Inter processing are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

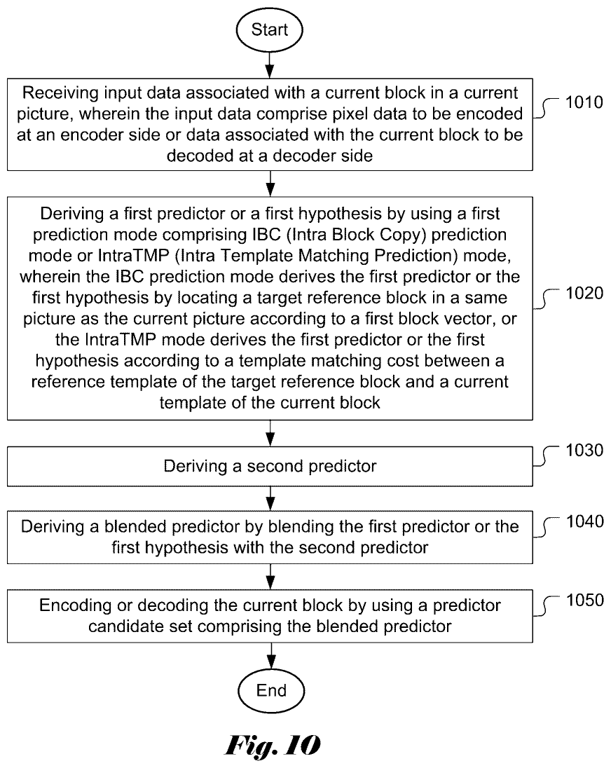

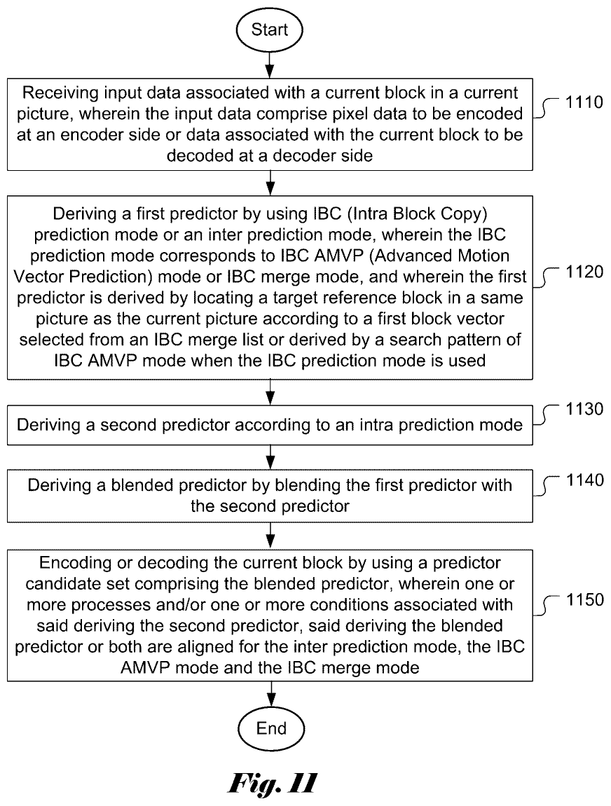

FIG. 10 illustrates a flowchart of an exemplary video coding system that uses blended IBC prediction mode according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block in a current picture are received in step 1010, wherein the input data comprise pixel data to be encoded at an encoder side or data associated with the current block to be decoded at a decoder side. A first predictor or a first hypothesis is derived by using a first prediction mode comprising IBC (Intra Block Copy) prediction mode or IntraTMP (Intra Template Matching Prediction) mode in step 1020, wherein the IBC prediction mode derives the first predictor or the first hypothesis by locating a target reference block in a same picture as the current picture according to a first block vector, or the IntraTMP mode derives the first predictor or the first hypothesis according to a template matching cost between a reference template of the target reference block and a current template of the current block. A second predictor is derived in step 1030. A blended predictor is derived by blending the first predictor or the first hypothesis with the second predictor in step 1040. The current block is encoded or decoded by using a predictor candidate set comprising the blended predictor in step 1050.

FIG. 11 illustrates a flowchart of an exemplary video coding system that uses IBC-CIIP prediction mode aligned among IBC AMVP mode, IBC merge mode and inter mode according to an embodiment of the present invention. According to this method, input data associated with a current block in a current picture are received in step 1110, wherein the input data comprise pixel data to be encoded at an encoder side or data associated with the current block to be decoded at a decoder side. A first predictor is derived by using IBC (Intra Block Copy) prediction mode or an inter prediction mode in step 1120, wherein the IBC prediction mode corresponds to IBC AMVP (Advanced Motion Vector Prediction) mode or IBC merge mode, and wherein the first predictor is derived by locating a target reference block in a same picture as the current picture according to a first block vector selected from an IBC merge list or derived by a search pattern of IBC AMVP mode when the IBC prediction mode is used. A second predictor is derived according to an intra prediction mode in step 1130. A blended predictor is derived by blending the first predictor with the second predictor in step 1140. The current block is encoded or decoded by using a predictor candidate set comprising the blended predictor in step 1150, wherein one or more processes and/or one or more conditions associated with said deriving the second predictor, said deriving the blended predictor or both are aligned for the inter prediction mode, the IBC AMVP mode and the IBC merge mode.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block in a current picture, wherein the input data comprise pixel data to be encoded at an encoder side or data associated with the current block to be decoded at a decoder side;
deriving a first predictor or a first hypothesis by using a first prediction mode comprising IBC (Intra Block Copy) prediction mode or IntraTMP (Intra Template Matching Prediction) mode, wherein the IBC prediction mode derives the first predictor or the first hypothesis by locating a target reference block in a same picture as the current picture according to a first block vector, or the IntraTMP mode derives the first predictor or the first hypothesis according to a template matching cost between a reference template of the target reference block and a current template of the current block;
deriving a second predictor;
deriving a blended predictor by blending the first predictor or the first hypothesis with the second predictor; and
encoding or decoding the current block by using a predictor candidate set comprising the blended predictor.

2. The method of claim 1, wherein the first predictor or the first hypothesis is generated by IBC AMVP mode or IBC merge mode.

3. The method of claim 1, wherein the first predictor or the first hypothesis is generated by multiplying a first IBC predictor in IBC AMVP mode and a second IBC predictor in IBC merge mode with weighting.

4. The method of claim 1, wherein multiple first predictors or multiple first hypotheses are generated and redundancy check is performed when the multiple first predictors or the multiple first hypotheses are generated.

5. (canceled)

6. The method of claim 1, wherein the first prediction mode comprises IBC merge mode, IBC AMVP mode, IBC GPM mode, IBC-CIIP mode, RRIBC mode, IBC-TM-inter mode, IBC-TM-merge mode, IBC-regular-merge mode, IBC-MBVD-merge mode, IBC-LIC mode, IBC-subblock mode, or a combination thereof.

7. The method of claim 1, wherein the second predictor is derived using a second prediction mode and second prediction mode comprises IBC merge mode, IBC AMVP mode, IBC GPM mode, IBC-CIIP mode, RRIBC mode, IBC-TM-inter mode, IBC-TM-merge mode, IBC-regular-merge mode, IBC-MBVD-merge mode, IBC-LIC mode, IBC-subblock mode, or a combination thereof.

8. The method of claim 1, wherein the first prediction mode corresponds to IBC with bi-prediction.

9. The method of claim 8, wherein a first BV (Block Vector) is derived by applying an IBC search algorithm and is used to locate a first referenced block for deriving a search pattern of a second BV.

10. The method of claim 8, wherein BVDs (BV Differences) and BVPs (BV Predictions) related to the bi-prediction are signalled or parsed from a bitstream comprising coded data of the current block.

11. The method of claim 8, wherein a first BVD associated with a first BV of the bi-prediction is signalled or parsed from a bitstream comprising coded data of the current block, and a second BVD associated with a second BV of the bi-prediction is inferred to be 0.

12. The method of claim 8, wherein a merge index is signalled or parsed from a bitstream comprising coded data of the current block to indicate a target merge candidate from an IBC merge list being used for the bi-prediction.

13. The method of claim 8, wherein a flag is signalled or parsed from a bitstream comprising coded data of the current block to indicate whether IBC AMVP mode is used for the bi-prediction.

14. The method of claim 8, wherein if the current block is coded in IBC AMVP mode, all candidates in an AMVP candidate list for the current block are bi-predictive motions, or a leading BV (Block Vector) of the current block is used to derive propagation intra mode.

15.

16. The method of claim 8, wherein when a current slice type for the current block is an I-slice, the blended predictor is generated by one IBC AMVP predictor and one IBC merge predictor.

17. The method of claim 8, wherein when a current slice type for the current block is a non-I-slice, the blended predictor is generated by blending one IBC AMVP predictor and one inter merge predictor, or is generated by blending one inter-AMVP predictor and one IBC merge predictor.

18. An apparatus for video coding, the apparatus comprising one or more electronics or processors arranged to:
receive input data associated with a current block in a current picture, wherein the input data comprise pixel data to be encoded at an encoder side or data associated with the current block to be decoded at a decoder side;
derive a first predictor or a first hypothesis by using a first prediction mode comprising IBC (Intra Block Copy) prediction mode or IntraTMP (Intra Template Matching Prediction) mode, wherein the IBC prediction mode derives the first predictor or the first hypothesis by locating a target reference block in a same picture as the current picture according to a first block vector, or the IntraTMP mode derives the first predictor or the first hypothesis according to a template matching cost between a reference template of the target reference block and a current template of the current block;
derive a second predictor;
derive a blended predictor by blending the first predictor or the first hypothesis with the second predictor; and
encode or decode the current block by using a predictor candidate set comprising the blended predictor.

19. A method of video coding, the method comprising:
receiving input data associated with a current block in a current picture, wherein the input data comprises pixel data to be encoded at an encoder side or data associated with the current block to be decoded at a decoder side;
deriving a first predictor by using IBC (Intra Block Copy) prediction mode or an inter prediction mode, wherein the IBC prediction mode corresponds to IBC AMVP (Advanced Motion Vector Prediction) mode or IBC merge mode, and wherein the first predictor is derived by locating a target reference block in a same picture as the current picture according to a first block vector selected from an IBC merge list or derived by a search pattern of IBC AMVP mode when the IBC prediction mode is used;
deriving a second predictor according to an intra prediction mode;
deriving a blended predictor by blending the first predictor with the second predictor; and
encoding or decoding the current block by using a predictor candidate set comprising the blended predictor, wherein one or more processes and/or one or more conditions associated with said deriving the second predictor, said deriving the blended predictor or both are aligned for the inter prediction mode, the IBC AMVP mode and the IBC merge mode.

20. The method of claim 19, wherein said one or more processes and/or said one or more conditions comprise at least one of intra list construction, blending weightings design, deblocking filtering, one or more constraints related current block size and motion referring by other blocks.

21. (canceled)

22. The method of claim 19, wherein said one or more processes and/or said one or more conditions are related to PDPC (Position Dependent Prediction Combination).

23. (canceled)

24. (canceled)

25. (canceled)

26. An apparatus for video coding, the apparatus comprising one or more electronics or processors arranged to:
receive input data associated with a current block in a current picture, wherein the input data comprises pixel data to be encoded at an encoder side or data associated with the current block to be decoded at a decoder side;
derive a first predictor by using IBC (Intra Block Copy) prediction mode or an inter prediction mode, wherein the IBC prediction mode corresponds to IBC AMVP (Advanced Motion Vector Prediction) mode or IBC merge mode, and wherein the first predictor is derived by locating a target reference block in a same picture as the current picture according to a first block vector selected from an IBC merge list or derived by a search pattern of IBC AMVP mode when the IBC prediction mode is used;
derive a second predictor according to an intra prediction mode;
derive a blended predictor by blending the first predictor with the second predictor; and
encode or decode the current block by using a predictor candidate set comprising the blended predictor, wherein one or more processes and/or one or more conditions associated with said deriving the second predictor, said deriving the blended predictor or both are aligned for the inter prediction mode, the IBC AMVP mode and the IBC merge mode.
